(19) United States
(12) Patent Application Publication
(10) Pub. No.: US 2006/0224275 A1
(43) Pub. Date: Oct. 5, 2006

(54) Device for an industrial robot

(76) Inventors: Magnus Heldesjo, Vasteras (SE); Daniel Lundback, Vasteras (SE)

Correspondence Address: VENABLE LLP, P.O. BOX 34385, WASHINGTON, DC, 20045-9998, US

(21) Appl. No.: 10/520,919

(22) PCT Filed: Jul. 4, 2003
(86) PCT No.: PCT/SE03/01171

§ 371 Date: Jan. 11, 2005

(30) Foreign Application Priority Data
Jul. 11, 2002 (SE) 02021764

(51) Int. Cl. G06F 19/00

(52) U.S. Cl. 700/245

(57) ABSTRACT

A device for restricting the working range around an axis of an industrial robot in the form of restriction of the maximum angle for rotation of the first part of the robot relative to a second part thereof, connected to the first part. The robot includes a fixed stop arranged at the second part, wherein the device includes a set of stop elements and aspects for fixing an optional number of stop elements on the first part in a row one after the other and making contact with one another along a circular arc around the axis of rotation of the first part, in order to hit against the stop with those end surfaces of the stop elements which are located on opposite ends of the row, when rotating the first part relative to the second part, thus forming opposite end positions for this rotation. The device includes members for such a mutual connection of stop elements arranged adjacent to each other in the row that these elements, with respect to the transmission of forces between them and the stop, when hitting against the latter upon the rotation, essentially behave as if they together were one single coherent stop element.

### TECHNICAL FIELD AND BACKGROUND ART

The present invention relates to the field of devices for restricting the working range around an axis of an industrial robot in the form of restriction of the maximum angle for rotation of a first part of the robot relative to a second part connected to the first part, wherein the first part is provided with a stop and the second part is provided with a stop element adapted to hit against the stop, when rotating the first part relative to the second part, thus forming opposite end positions for this rotation. The industrial robot may be of any type.

An industrial robot is usually programmed to operate within a certain working range. For safety reasons, it is furthermore often prescribed that the working range for certain axes of the robot shall be restricted, from the hardware point of view, by means of mechanical or electric stop means. In this way, an emergency stop of the robot is released if the robot, due to a fault in the control system, should attempt to move outside the programmed working range.

Devices of this kind for achieving such a restriction of the movement are known from, for example, U.S. Pat. No. 3,954,188, EP 0 241 566 and SE 469 878. Admittedly, these devices enable moving the stop element along the first part, but a disadvantage thereof is that they do not allow defining the maximum angle for relative rotation of the parts and changing this angle, through opposite end surfaces of the stop element itself. To solve this problem, a device of the kind described in the introductory part of the description is known, said device comprising a set of stop elements and means for fixing a varying number of the stop elements on the first part in a row one after the other and adjacent to each other along a circular arc around the axis of rotation of the first part in order to hit against the stop with those end surfaces of the stop elements which are located at opposite ends of the row, when rotating the first part relative to the second part, thus forming opposite end positions for this rotation.

By providing such a set of stop elements, which are formed from blocks having essentially the shape of truncated sectors of a circle, different numbers or combinations of such blocks may be arranged one after the other on said row to cover angles of rotation, of various magnitudes, around said axis in dependence on the current requirements. However, the means for fixing these blocks to the first part, for example a robot arm or a robot foot, which may be in the form of bolts, are subjected to very considerable loads when the first stop element, viewed in the direction of movement, is at some time run against the fixed stop. For this reason, various measures must be taken to prevent said means from bursting or becoming deformed. One possibility is to try to reinforce the bolts or to apply extra support for the stop elements in a radial direction, since the tangential force transmitted from the fixed stop to said first stop element will give rise to considerable radial forces on the means for fixing, such as the bolts further downstream in the row. At the same time, after 90° from the impact end surface of the row of stop elements, the tangential force will be almost zero and substantially no force be transmitted to stop elements appearing downstream in the row. This means that the first bolts must take up all the force. It is both complicated and costly to arrive at such solutions to the problem of transmitting the impact forces to the fixing means of the stop elements.

### SUMMARY OF THE INVENTION

The object of the present invention is to provide a device of the kind which is defined in the preamble to the appended claim 1 and which provides a far-reaching solution to the problem, discussed above, arising in such prior art devices.

This object is achieved according to the invention by providing the above-mentioned device with means for such mutual connection of stop elements arranged adjacent to each other in said row that these elements, with respect to the transmission of forces between them and the stop when striking against the stop upon said rotation, essentially behave as if they together were one coherent stop element.

Since the stop elements in this way act as if they were one single stop element, the force transmitted to them via the stop may be taken up by considerably more fixing means, for example screws, than if the stop elements should act as individual parts. Thus, the tangential force arising upon impact of the front stop element in the row against the stop will be capable of being transmitted from one stop element to another stop element and hence, to the greatest possible extent, the force be transmitted to the body of the first part that the stop elements are fixed to. This implies that the fixing means are spared great shear stresses in a radial direction, so that they do not have to be oversized or be reinforced by radial supports for the stop elements.

According to a preferred embodiment of the invention, said connection members are arranged, when forming said row, to bring about mechanical interlocking between adjacent stop elements. This makes possible a simple mounting of the stop elements in situ while at the same time achieving a reliable and effective locking of the elements so as to act, with respect to the force transmitted via the stop, as one single element. This also makes it possible to use simple and inexpensive manufacturing processes both for the stop elements and the surface on which they are intended to be screwed to the first part.

According to another preferred embodiment of the invention, the connection members comprise tooth-shaped projections on those surfaces of the stop elements which are essentially tangentially directed when a row has been formed, and recesses corresponding thereto in corresponding surfaces on adjacent stop elements. This constitutes a very simple and efficient way of forming said interlocking. In addition, the assembly is very simple in that adjacent stop elements may be pushed in an essentially tangential direction with the teeth and recesses into each other before being fixed to the first part.

According to a further preferred embodiment of the invention, when a row has been formed, the connection members comprise, at the essentially tangentially directed ends of the stop elements, essentially axially extending grooves or recesses and projections which fit therein and which are adapted to be axially inserted into these. The projections may have the shape of a dovetail or any other shape. Also this embodiment exhibits the advantages mentioned for the preceding embodiment.

The invention also relates to a method for achieving a restriction of the working range around an axis of an industrial robot according to the appended method claims.

Additional advantages, and advantageous features, of the invention will be clear from the following description and the other dependent claims.

### BRIEF DESCRIPTION OF THE DRAWINGS

Preferred exemplary embodiments of the invention will now be described with reference to the accompanying drawings, wherein

FIG. 1 shows a side view of an industrial robot, around the different axes of rotation of which the working range may be restricted by a device according to the invention,

FIG. 2 is a perspective view of part of an industrial robot with a device according to a preferred embodiment of the invention applied to a joint between two arms of the robot,

FIG. 3 is a partially cut-away view of a joint of an industrial robot provided with a device according to the invention,

FIG. 4 is a detailed view of a stop element of a device according to a preferred embodiment of the invention, and

FIG. 5 is a detailed view of a stop element of a device according to another preferred embodiment of the invention.

### DETAILED DESCRIPTION OF PREFERRED EMBODIMENTS OF THE INVENTION

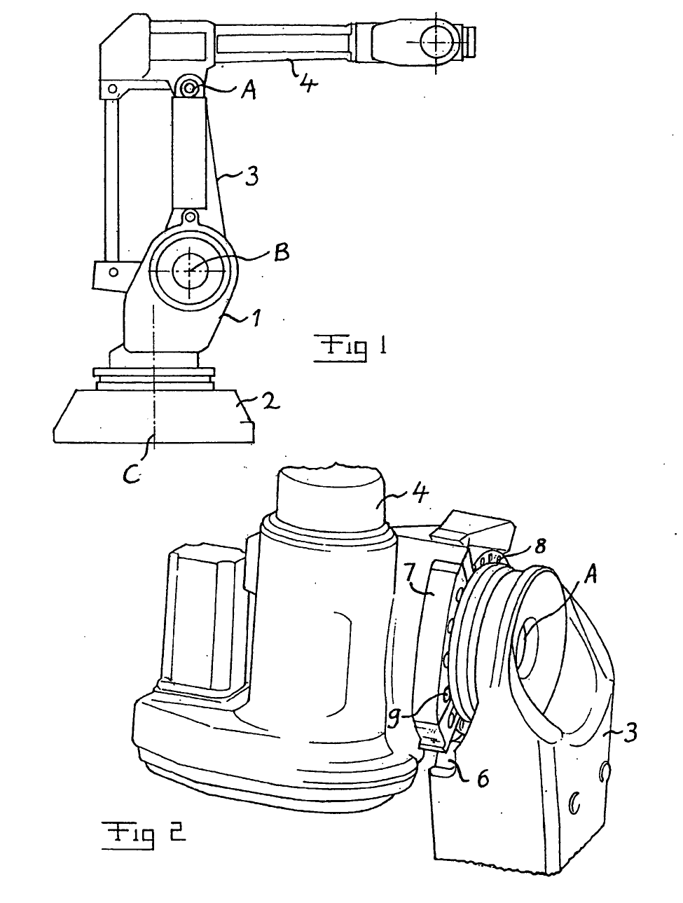

FIG. 1 shows one possible type of industrial robot, to which a device for restriction of the working range according to the invention may be applied. The robot has a stand 1 which is rotatably journalled, around a vertical axis C, in a robot foot 2 secured to a mounting base. A first robot arm 3 is pivotally journalled at the stand 1 around an axis B. At the upper end of the arm 3, a second robot arm 4 is pivotally journalled around an axis A.

The working ranges of the axes A, B and C are restricted, for safety reasons, with the aid of mechanical or electrical stop means, such as a mechanical stop means of the kind to which the present invention relates and which will be described hereinafter while at the same time referring to FIGS. 2 and 3.

FIG. 2 illustrates how a device according to the invention is arranged for restricting the working range in the form of the maximum angle for rotation of an upper robot arm 4 relative to a lower robot arm 3 around an axis A. Two fixed stops 5, 6 with essentially tangentially directed stop surfaces, relative to the axis of rotation A, are arranged on the lower robot arm 3. The stops 5, 6 preferably consist of lugs formed when casting the body of the arm 3.

The device further comprises a set of stop elements 7, 7′, 7″ in the form of blocks essentially shaped as truncated sectors of a circle, which are arranged to be placed in a row one after the other and making contact with one another on the upper arm 4, or a part secured thereto, along a circular arc around the axis of rotation A. The arm 4 exhibits first holes 8, distributed around the axis A, and the stop elements exhibit second holes 9 for inserting bolts 14, screws, or the like, for fixing the stop elements relative to the arm 4. In this way, upon rotation of the arm 4 around the axis A, the stop elements will hit against the stops 5 and 6, respectively, with end surfaces located at opposite ends of the rows, thus forming opposite end positions for the rotation. The set of stop elements may be combined in an arbitrary manner and be fixed by means of the fixing means (the screws) at different desired locations around the axis A, to define different desired end positions of the working range of the industrial robot around the axis A. For this sake, the stop elements may, for example, exhibit a few, possibly only one, stop element adapted to extend through a relatively large angle along said circular arc, for example through 60°, preferably between 65° and 90°, whereas it may contain considerably more small stop elements with a corresponding angle of between 10° and 40°, preferably between 15° and 30°. This may be advantageous in those cases where, for example, said row shall alternately cover an angle interval of between 100° and 150°, since a “large stop element” in this case may be combined with, for example, 1-4 “small stop elements”. It is, of course, fully possible for the set also to contain stop elements of an intermediate size.

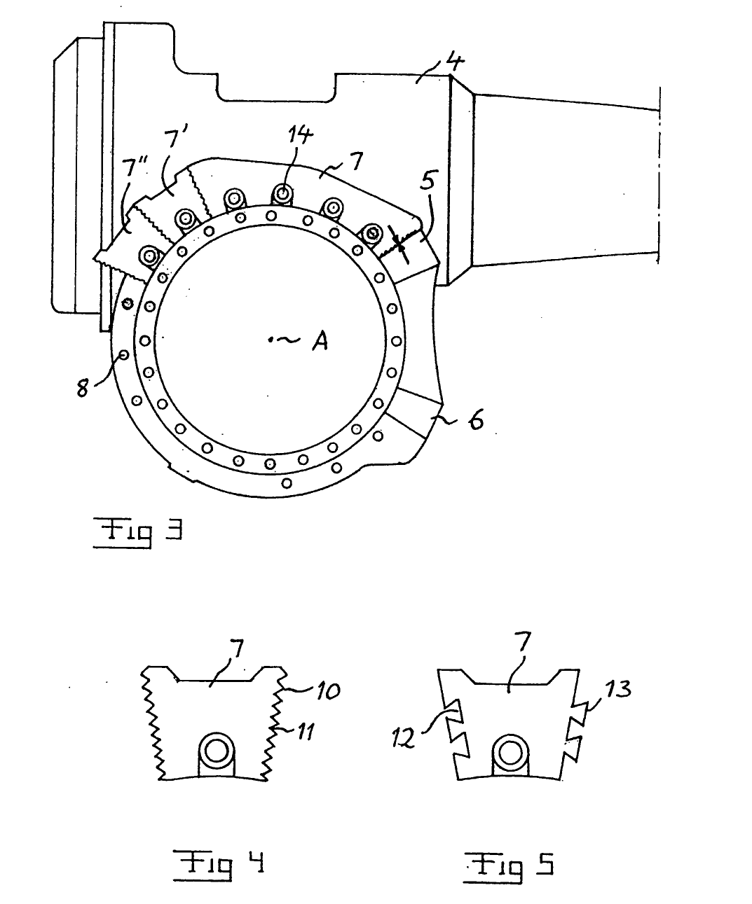

In the device according to the invention, members are provided for mutually connecting stop elements arranged adjacent to each other in said row so that these elements, with respect to transmission of forces between them and the stops 5, 6, when hitting against the stops upon rotation, behave essentially as if they together were one single coherent stop element. In the preferred embodiments shown, the connecting members are arranged on the stop elements themselves to bring about mechanical interlocking between adjacent stop elements, and in the embodiment illustrated in FIGS. 3 and 4 this is achieved by arranging tooth-like projections 10 on the essentially tangentially directed surfaces of the stop elements, when a row has been formed, and by forming recesses 11, corresponding thereto, on corresponding surfaces of adjacent stop elements. The teeth 10 and the recesses 11 are preferably elongated in the form of ridges and valleys, which ensures a very good interlock and transmission of forces therebetween, and it is especially preferred that they have an axial longitudinal extension in the position of the stop element around the axis. To obtain an optimum transmission of forces between the stop elements, a tooth on one side of a stop element is preferably followed by a tooth in an exactly corresponding position of the stop element on the opposite side of this stop element.

FIG. 5 illustrates how the stop elements may exhibit different members for mutual mechanical interlocking, and here the tangentially directed ends of the stop elements are provided with essentially axially extending grooves 12 and projections 13 fitting therein and adapted to be inserted axially into these. In this case, the grooves and the projections exhibit a dovetail-shaped cross section, but other cross-section shapes are also feasible. The important thing is that the connecting members counteract relative motion of adjacent stop elements in a radial direction, so that when applying an essentially tangentially directed force to the front surface of a stop element, as viewed in the direction of movement, when hitting against a stop, this force may be forwarded from that stop element to the next as if this in practice constituted one coherent portion of the first stop element. This will mean that the stop elements, with respect to the transmission of this force generated upon impact against the stop, will act as if they were one single stop element and thereby the force be distributed and taken up by considerably more fixing means 14 than in the absence of the interlock. Thus, the connecting members could also be formed from essentially tangentially directed fingers and corresponding recesses in the end surfaces of the respective stop element for insertion thereinto in an essentially tangential direction, such as for the teeth in the embodiment shown in FIG. 4. The stop element blocks are advantageously made from extruded aluminium, which provides good possibilities of creating a complex two-dimensional geometry with good possibilities for tolerance.

The invention is not, of course, in any way limited to the preferred embodiments described above, but numerous possibilities of modifications thereof should be obvious to a person skilled in the art without this person for that reason deviating from the basic concept of the invention as described in the appended claims.

For example, connecting members other than those shown and/or discussed above are possible, and it is within the scope of the invention, for example, to connect adjacently positioned stop elements to one another in other ways, so that they behave in this respect as if they were one single coherent stop element, than by mutual interlocking, such as by means of members which are completely separate from the stop elements and which are applied at the transition between adjacent stop elements, for example yoke-like elements with branches that are inserted into recesses in the respective stop elements or the like. However, interlocking seems to be preferable in most applications because of its simplicity and great reliability. Thus, the expression that the stop elements are intended, with respect to the transmission of forces between them, to behave as one single coherent stop element, embraces all types of mutual connection between them which results in this behaviour but which allows subsequent detachment to enable the set of stop elements to be optionally combined again. Consequently, permanent gluing of the stop elements is not included.

From the reasoning above it should be clear that the claims are also intended to cover the case where it is not one and the same stop (although it may be) that the opposite end surfaces of the row of stop elements are intended to hit against when reaching the respective limit to the working range.

It is also fully possible that, in practice, only one end surface of the row of stop elements has any possibility to reach and hit against the fixed stop, and that the second limit to the working range, which is defined by the stop elements, can never be reached since the opposite end surface of the row of stop elements hits against a stop because other restrictions of the movement are inherent in the device. The definition in the claim, “in order to hit against the stop with those end surfaces of the stop elements which are located at opposite ends of the row, when rotating the first part relative to the second part, thus forming opposite end positions for this rotation”, should also be interpreted to cover such a case.

The teeth could be shaped like pyramids or cones or differ from ridges in some other way by interruptions, and the recesses could be modified in a corresponding way.

In the example shown, of course, the fixed stops could just as well be arranged on the upper arm and the stop elements on the lower arm.

Damper layers, for example of rubber, absorbing kinetic energy may be arranged on the surface of the stop and designed to be hit by the “foremost” stop element in the row and/or on the front surface of this stop element, as viewed in the direction of movement, and this is intended to be covered by the definition in the claim that the stop element hits against the stop.

1. A device for restricting the working range around an axis of an industrial robot in the form of restriction of the maximum angle for rotation of the first part of the robot relative to a second part thereof, connected to the first part, wherein the robot comprises a fixed stop arranged at the second part, wherein the device comprises a set of stop elements and means for fixing an optional number of stop elements on the first part in a row one after the other and making contact with one another along a circular arc around the axis of rotation of the first part, in order to hit against the stop with those end surfaces of the stop elements which are located on opposite ends of the row, when rotating the first part relative to the second part, thus forming opposite end positions for this rotation, wherein the device comprises members for such a mutual connection of stop elements arranged adjacent to each other in said row that these elements, with respect to the transmission of forces between them and the stop, when hitting against the latter upon said rotation, essentially behave as if they together were one single coherent stop element.

2. The device according to claim 1, wherein said connecting members are adapted, when forming said row, to achieve mechanical interlocking between adjacent stop elements.

3. The device according to claim 2, wherein said connecting members comprise tooth-like projections on the essentially tangentially directed surfaces of the stop elements, when a row has been formed, and recesses corresponding thereto on corresponding surfaces of adjacent stop elements.

4. The device according to claim 2, wherein the connecting members comprise, at the essentially tangentially directed ends of the stop elements, when a row has been formed, essentially axially extending grooves or recesses and projections fitting therein and adapted to be inserted into these.

5. The device according to claim 1, wherein said fixing means comprise first holes distributed around the axis of rotation of the arm in said first part and second holes arranged in the stop elements, as well as elongated rod-shaped pieces which are each adapted to be inserted through a first and a second hole for fixing the respective stop element to the first part.

6. The device according to claim 5, characterized in that wherein said pieces are bolts designed for screwing the stop elements to said first part.

7. The device according to claim 1, wherein said set of stop elements comprises stop elements of mutually considerably different lengths with respect to the angle through which they are intended to extend along said circular arc.

8. The device according to claim 7, wherein said set includes 1-3 first stop elements with a considerably larger said angle than the other stop elements which are larger in number than the first ones.

9. The device according to claim 8, wherein said set includes at least one first stop element with a said angle exceeding 60°.

10. The device according to claim 8, wherein said set includes several, other stop elements with a said angle between 10° and 40°.

11. The device according to claim 1, wherein the stop elements are formed from blocks having essentially the shape of truncated sectors of a circle.

12. The device according to claim 1, wherein said means are adapted to fix the stop elements to an arm of an industrial robot.

13. The device according to claim 1, wherein it is designed for application to a rotary joint between first and second parts in the form of two arms of an industrial robot.

14. The device according to claim 1, wherein it is designed for application to a rotary joint in the form of a stand and a robot foot of an industrial robot.

15. A method for providing a restriction of the working range around an axis of an industrial robot in the form of restriction of the maximum angle for rotation of a first part of the robot relative to a second part thereof, connected to the first part, wherein the robot comprises a fixed stop arranged at the second part, to which an optional number of a set of stop elements are fixed to the first part in a row one after the other and making contact with one another along a circular arc around the axis of rotation of the first part, in order to hit against the stop with those end surfaces of the stop elements which are located at opposite ends of the row, when rotating the first part relative to the second part, thus forming opposite end positions for this rotation, wherein stop elements located adjacent to each other in said row are mutually connected to one another in such a way that these stop elements, with respect to the transmission of forces between them and the stop, when hitting against the latter upon said rotation, essentially behave as if they together were one single coherent stop element.

16. The method according to claim 15, wherein adjacently located stop elements are mutually connected to one another by joining them together to achieve mechanical interlocking thereof to one another.

17. The device according to claim 8, wherein said set includes at least one first stop element with a said angle between 65° and 90°.

18. The device according to claim 8, wherein said set includes several other stop elements with a said angle between 15° and 30°.

19. The device according to claim 8, wherein said set includes 3-6 other stop elements with a said angle between 10° and 40°.

20. The device according to claim 8, wherein said set includes 3-6 other stop elements with a said angle between 15° and 30°.
